(19) United States
(12) Patent Application Publication
(10) Pub. No.: US 2008/0186513 A1
(43) Pub. Date: Aug. 7, 2008

(54) Method of measuring gap depth of thin film magnetic head for horizontal magnetic recording, and method of measuring neck height of thin film magnetic head for vertical magnetic recording

(75) Inventor: Ryuei Ono, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/986,095

(22) Filed: Nov. 20, 2007

(30) Foreign Application Priority Data
Feb. 6, 2007 (JP) 2007-027351
Apr. 24, 2007 (JP) 2007-113751

(51) Int. Cl. G01B 11/22

(52) U.S. Cl. 356/614

(57) ABSTRACT

By the method of measuring a gap depth of a thin film magnetic head for horizontal magnetic recording, the gap depth of a write-magnetic pole can be easily and correctly measured. The method comprises the steps of: forming a first standard marker; measuring a distance between an actual position of a rear end of a lapping guide and the position of the first standard marker; calculating a lapping guide shift length; forming a second standard marker; measuring a distance between an actual position of a zero throat and a position of the second standard marker; calculating a zero throat shift length; and calculating an actual gap depth of a write-magnetic pole by adding the lapping guide shift length and the zero throat shift length to a designed gap depth.

### BACKGROUND OF THE INVENTION

The present invention relates to: a method of measuring a gap depth of a thin film magnetic head for horizontal magnetic recording, wherein the gap depth is a distance between a front end of a write-magnetic pole exposed in a floating surface and a zero throat thereof and wherein a position of the floating surface is defined on the basis of a width of a lapping guide in an anteroposterior direction perpendicular to the floating surface in a step of forming the floating surface by a lapping process; and a method of measuring a neck height of a thin film magnetic head for vertical magnetic recording, wherein the neck height is a distance between a front end of a write-main magnetic pole exposed in a floating surface and a neck leader thereof and wherein a position of the floating surface is defined on the basis of a width of a lapping guide in an anteroposterior direction perpendicular to the floating surface in a step of forming the floating surface by a lapping process.

A conventional method of producing a thin film magnetic head will be explained. Firstly, a number of element sections, e.g., read-elements, write-magnetic poles, each of which is constituted by multilayered thin films and which are arranged in a matrix on a wafer substrate 70 composed of Al₂O₃TiC, are formed as shown in FIG. 14A. Next, the wafer substrate 70 is cut to form into raw bars 72, each of which includes a line of the element sections, as shown in FIG. 14B, and then each of the raw bars 72 is lapped to simultaneously form floating surfaces of the elements. Finally, each of the raw bars 72 is cut to form a plurality of sliders 72, each of which includes the element sections, as shown in FIG. 14 C.

FIG. 7 is an anteroposterior sectional view of a thin film magnetic head for horizontal magnetic recording. Note that, in the following description, a direction perpendicular to the floating surface 48 is called an anteroposterior direction. The floating surface side of the thin film magnetic head is a front side (anterior-side), and the other side thereof is a rear side (posterior-side).

In the lapping step, as shown in FIG. 7, a position c of the floating surface 48, in an anteroposterior direction a, is defined by: detecting a width (MR height) b of a CIP type read-element (MR element) 22 in the anteroposterior direction a perpendicular to the floating surface 48; and adjusting the amount of lapping. Namely, the anteroposterior position c of the floating surface 48 is defined on the basis of a rear end 22a of the read-element 22. In the lapping step, the MR height b of the read-element 22 is detected by measuring resistance, output voltage, etc. of read-terminals (not shown) connected to the read-element 22. Namely, the read-element 22 can be used as a so-called resistance lapping guide (RLG).

In the thin film magnetic head for horizontal magnetic recording, a write-characteristic of a write-magnetic pole is influenced by a gap depth. The gap depth is a distance d between a front end 46a of an upper magnetic pole 46 of the write-magnetic pole, which is exposed in the floating surface 48, and a zero throat 42.

The upper magnetic pole 46 is constituted by: a gap layer 38, which is formed on a lower magnetic pole 34; and an insulating layer 40, whose front part 40a is inclined and gradually made thicker toward a rear end from a position located on the gap layer 38 and separated a prescribed distance from the floating surface 48. A rising point 42 of the inclination part (apex part) 40a, which is a border between the gap layer 38 and the insulating layer 40, is called a zero throat.

The front end 46a side of the upper magnetic pole 46 with respect to the zero throat 42 is a tip section, in which a core width is constant; the rear side of the upper magnetic pole 46 with respect to the zero throat 42 is a yoke section, in which the core width is gradually made wider toward the rear end.

Since the gap depth d is the distance between the floating surface 48 (the front end 46a) and the zero throat 42, it is influenced by the anteroposterior position c of the floating surface 48 defined by the lapping process. Namely, in case that the position c of the floating surface 48 is located on the front side with respect to the zero throat 42, the gap depth d is increased; in case that the position c of the floating surface 48 is located on the rear side with respect to the zero throat 42, the gap depth d is reduced.

The gap depth d highly influences the write-characteristic of the write-magnetic pole.

However, the position c of the floating surface 48 is not defined on the basis of the gap depth d and the zero throat 42. As described above, the position c is defined on the basis of the anteroposterior width (MR height) b of the read-element 22. Therefore, if a relative position of the zero throat 42 with respect to the rear end 22a of the read-element 22 is shifted from a designed position (desired position), the gap depth d is also shifted from a designed value (desired value) and the write-characteristic is badly influenced.

Causes of shifting the relative anteroposterior position of the zero throat 42, with respect to the rear end 22a of the read-element 22, from a desired position are displacement of mutual positions of thin films in a laminating step and deformation of the read-element 22, e.g., shrink, in a processing step, e.g., etching step.

By the causes, the gap depth d will be shifted from a designed value (desired value). Thus, conventionally, a sample breaking test is performed to measure the gap depth d, and the measurement result is given feedback to the laminating step of the production process of the following thin film magnetic head so as to precisely adjust the laminating positions of the thin films.

As shown in FIG. 14D, the sample breaking test is performed by the steps of: selecting a sample slider 74a from sliders 74, which have been cut from a raw bar 72 after processing floating surfaces thereof; cutting the sample slider 74a along an anteroposterior axis thereof; manually polishing a sectional face thereof; and observing the polished sectional face by a scanning electron microscope (SEM) so as to measure a gap depth, which is a distance between a floating surface and a zero throat.

A method of producing a thin film magnetic head, in which a gap depth can be correctly formed, is disclosed in Japanese Patent Gazette No. 9-54912.

The method comprises the steps of: forming a process monitor which can be observed from outside when a floating surface is lapped; measuring and calculating relative positions of the process monitor and an apex (zero throat); and precisely adjusting a position of the floating surface by lapping the floating surface on the basis of the position of the process monitor. With this method, the gap depth can be correctly formed.

Concretely, as shown in FIG. 15, firstly a plurality of the process monitors 16 are formed in parallel with the element sections formed on the wafer substrate. The process monitors 16 are vapor-deposited titanium films and simultaneously formed into prescribed shapes when coils of write-magnetic poles are formed (see paragraph 0016 of the patent gazette). The process monitors 16 are respectively provided to both ends of a raw bar 12, which is a block including a line of the element sections (see paragraph 0014 of the patent gazette).

In a state of exposing the apex part (zero throat), a line connecting the apex parts of the element sections and a line connecting standard positions of the process monitors 16 located at the ends of the raw bar 12 are detected before laminating an upper magnetic pole of the write-magnetic pole (paragraphs 0017 and 0018 of the patent gazette).

The lapping process is performed by: detecting a width of each process monitor 16 from the standard position; calculating an apex position from the detected width and a distance between the line connecting the apex parts of the element sections and the line connecting the standard positions of the process monitors 16; and adjusting amount of lapping or the position of the floating surface in the anteroposterior direction so as to make the gap depth, which is the distance between the floating surface and the apex position (zero throat), equal to a desired value (see paragraph 0019-0022 of the patent gazette).

Note that, in the patent gazette, the standard positions of the process monitors 16 are varied by influence of etching. Thus, the variation with respect to barycentric positions of lap marks 18, which are respectively formed near the element sections (see paragraph 0020 of the patent gazette).

In the measurement of the gap depth by the breaking test (see FIG. 14D), the sectional surface of the slider 74a is manually polished, so the surface condition is easily varied, and the breaking test includes many steps. Therefore, it is impossible to perform the breaking test with a lot of samples.

In the method disclosed in the Japanese patent gazette, even if the gap depth of the write-magnetic pole is optimally processed in the lapping step for forming the floating surface, a MR height of a read-element will be varied because the MR height is not measured and detected. Therefore, characteristics of the read-element will be varied.

### SUMMARY OF THE INVENTION

The present invention was conceived to solve the above described problems.

An object of the present invention is to provide a method of measuring a gap depth of a thin film magnetic head for horizontal magnetic recording, in which a position of a floating surface is defined on the basis of a width of a lapping guide in an anteroposterior direction (a direction perpendicular to the floating surface) and the gap depth of a write-magnetic pole can be easily and correctly measured without being influenced by shrink, etc. in a step of etching the lapping guide.

Another object is to provide a method of measuring a neck height of a thin film magnetic head for vertical magnetic recording, in which a position of a floating surface is defined on the basis of a width of a lapping guide in the anteroposterior direction and the neck height of a write-magnetic pole, which influences a write-characteristic, can be easily and correctly measured without being influenced by shrink of the lapping guide, etc.

Further object is to provide a method of producing a thin film magnetic head for horizontal magnetic recording and a method of producing a thin film magnetic head for vertical magnetic recording.

To achieve the objects, the present invention has following constitutions.

Namely, the method of measuring a gap depth of a thin film magnetic head for horizontal magnetic recording comprises the steps of: forming a lapping guide; forming a first standard marker at a position which is shifted a first specified distance, in an anteroposterior direction, from a designed position of a rear end of the lapping guide; measuring a distance, in the anteroposterior direction, between an actual position of the rear end of the lapping guide and the position of the first standard marker; calculating a lapping guide shift length, which is a length between the measured distance and the first specified distance; forming a gap layer of a write-magnetic pole for horizontal magnetic recording; forming an insulating layer, which has an apex part, on the gap layer; forming a second standard marker at a position which is shifted a second specified distance, in the anteroposterior direction, from a designed position of a zero throat of the apex part; measuring a distance, in the anteroposterior direction, between an actual position of the zero throat and the position of the second standard marker; calculating a zero throat shift length, which is a length between the measured distance and the second specified distance; and calculating an actual gap depth of the write-magnetic pole by adding the lapping guide shift length and the zero throat shift length to a designed gap depth.

Another method of measuring a gap depth of a thin film magnetic head for horizontal magnetic recording comprises the steps of: forming a lapping guide; forming a first standard marker at a position which is shifted a first specified distance, in an anteroposterior direction, from a designed position of a rear end of the lapping guide; measuring a distance, in the anteroposterior direction, between an actual position of the rear end of the lapping guide and the position of the first standard marker; storing a datum of a lapping guide shift length, which is a length between the measured distance and the first specified distance, in a storing section; forming a gap layer of a write-magnetic pole for horizontal magnetic recording; forming an insulating layer, which has an apex part, on the gap layer; forming a second standard marker at a position which is shifted a second specified distance, in the anteroposterior direction, from a designed position of a zero throat of the apex part; measuring a distance, in the anteroposterior direction, between an actual position of the zero throat and the position of the second standard marker; storing a datum of a zero throat shift length, which is a length between the measured distance and the second specified distance, in the storing section; and calculating an actual gap depth of the write-magnetic pole by adding the lapping guide shift length and the zero throat shift length, which have been stored as the data, to a designed gap depth.

In each of the above described methods, the shift of the rear end of the lapping guide, which is caused by shrink, etc. of the lapping guide during a step of etching the lapping guide, is measured on the basis of the first standard marker. Then, the insulating layer is formed on the gap layer, and the zero throat shift length is measured on the basis of the second standard marker. Since the position of the floating surface is defined by the rear end of the lapping guide, the actual gap depth can be gained by adding the lapping guide shift length and the zero throat shift length to the designed gap depth.

Each of the methods may further comprise the step of measuring a standard marker shift length, which is a difference between: a shift length of the first standard marker, in the anteroposterior direction, between a designed position of the first standard marker and an actual position thereof; and a shift length of the second standard marker, in the anteroposterior direction, between a designed position of the second standard marker and an actual position thereof, wherein the actual gap depth of the write-magnetic pole is calculated by adding the lapping guide shift length, the zero throat shift length and the standard marker shift length to the designed gap depth in said step of calculating the actual gap depth of the write-magnetic pole.

With this method, shifts of the first standard marker and the second standard marker can be absorbed, so that the gap depth can be more correctly measured.

In the method, the designed positions of the first standard marker and the second standard marker in the anteroposterior direction may be conformed.

Further, in the method, the first standard marker may be formed at a position shifted rearward from the designed position of the rear end of the lapping guide, and the second standard marker may be formed at a position shifted forward from the designed position of the zero throat.

With this method, the distance between the first standard marker and the rear end of the lapping guide and the distance between the second standard marker and the zero throat can be made small, so that measurement errors of the distances can be restrained.

In the method, a first overlay marker may be formed in said step of forming the first standard marker, a second overlay marker may be formed in said step of forming the second standard marker, and the standard marker shift length may be measured on the basis of shift lengths of the first overlay marker and the second overlay marker.

With this method, the standard marker shift length can be precisely gained.

The method may further comprise the steps of: forming a standard overlay marker in a layer, which is formed under a layer including the first overlay marker; measuring a first overlay marker shift length, in the anteroposterior direction, between the standard overlay marker and the first overlay marker; and measuring a second overlay marker shift length, in the anteroposterior direction, between the standard overlay marker and the second overlay marker, wherein the standard marker shift length is calculated on the basis of a difference between the first overlay marker shift length and the second overlay marker shift length.

In the method, at least one of the first standard marker and the second standard marker may be formed, by a photolithographic method, with resist.

With this method, the standard marker can be precisely formed by the photolithographic method, so that the shift lengths with respect to the standard marker can be correctly measured.

In the method, the first standard marker may be line-symmetrically formed in the anteroposterior direction, and a distance, in the anteroposterior direction, between the actual position of the rear end of the lapping guide and an anteroposterior center of the first standard marker may be measured.

With this method, the first standard marker is line-symmetrically formed in the anteroposterior direction. Even if the first standard marker is shrunk during the processing step, the standard center of the first standard marker in the anteroposterior direction is not changed. Therefore, the shift length of the rear end of the lapping guide can be correctly measured.

In the method, the first standard marker may be formed on an anteroposterior center line of the lapping guide.

With this method, the lapping guide shift length can be easily and correctly gained by measuring a linear distance between the first standard marker and the rear end of the lapping guide.

In the method, the second standard marker may be line-symmetrically formed in the anteroposterior direction, and a distance, in the anteroposterior direction, between the actual position of the zero throat and an anteroposterior center of the second standard marker may be measured.

With this method, the second standard marker is line-symmetrically formed in the anteroposterior direction. Even if the second standard marker is shrunk during the processing step, the standard center of the second standard marker in the anteroposterior direction is not changed. Therefore, the shift length of the zero throat can be correctly measured.

In the method, the second standard marker may be formed on an anteroposterior center line of the write-magnetic pole.

With this method, the zero throat shift length can be easily and correctly gained by measuring a linear distance between the second standard marker and the zero throat.

In the method, the lapping guide may be a CIP type read-element of the thin film magnetic head for horizontal magnetic recording.

With this method, a MR height can be correctly set.

The method of producing a thin film magnetic head for horizontal magnetic recording comprises the steps of one the above described methods, wherein an angle of a floating surface is adjusted so as to approximate the gap depth to the designed gap depth, in the step of lapping the floating surface, when the measured gap depth is different from the designed gap depth.

With this method, the actual gap depth of the write-magnetic pole can be approximated to the designed value.

The method of measuring a neck height of a thin film magnetic head for vertical magnetic recording comprises the steps of: forming a lapping guide; forming a first standard marker at a position which is shifted a first specified distance, in an anteroposterior direction, from a designed position of a rear end of the lapping guide; measuring a distance, in the anteroposterior direction, between an actual position of the rear end of the lapping guide and the position of the first standard marker; calculating a lapping guide shift length, which is a length between the measured distance and the first specified distance; forming a write-main magnetic pole for vertical magnetic recording; forming a second standard marker at a position which is shifted a second specified distance, in the anteroposterior direction, from a designed position of a neck leader, which is a border between a neck part and a yoke part of a pole end in the write-main magnetic pole; measuring a distance, in the anteroposterior direction, between an actual position of the neck leader and the position of the second standard marker; calculating a neck leader shift length, which is a length between the measured distance and the second specified distance; and calculating an actual neck height of the write-main magnetic pole by adding the lapping guide shift length and the neck leader shift length to a designed neck height.

Another method of measuring a neck height of a thin film magnetic head for vertical magnetic recording comprises the steps of: forming a lapping guide; forming a first standard marker at a position which is shifted a first specified distance, in an anteroposterior direction, from a designed position of a rear end of the lapping guide; measuring a distance, in the anteroposterior direction, between an actual position of the rear end of the lapping guide and the position of the first standard marker; storing a datum of a lapping guide shift length, which is a length between the measured distance and the first specified distance, in a storing section; forming a write-main magnetic pole for vertical magnetic recording; forming a second standard marker at a position which is shifted a second specified distance, in the anteroposterior direction, from a designed position of a neck leader, which is a border between a neck part and a yoke part of a pole end in the write-main magnetic pole; measuring a distance, in the anteroposterior direction, between an actual position of the neck leader and the position of the second standard marker; storing a datum of a neck leader shift length, which is a length between the measured distance and the second specified distance, in the storing section; and calculating an actual neck height of the write-main magnetic pole by adding the lapping guide shift length and the neck leader shift length, which have been stored as the data, to a designed neck height.

In each of the above described methods, the shift of the rear end of the lapping guide, which is caused by shrink, etc. of the lapping guide during a step of etching the lapping guide, is measured on the basis of the first standard marker. Then, the write-magnetic pole is formed, and the neck leader shift length is measured on the basis of the second standard marker. Since the position of the floating surface is defined by the rear end of the lapping guide, the actual neck height can be gained by adding the lapping guide shift length and the neck leader shift length to the designed gap depth.

Each of the methods may further comprise the step of measuring a standard marker shift length, which is a difference between: a shift length of the first standard marker, in the anteroposterior direction, between a designed position of the first standard marker and an actual position thereof, and a shift length of the second standard marker, in the anteroposterior direction, between a designed position of the second standard marker and an actual position thereof, wherein the actual gap depth of the write-magnetic pole calculated by adding the lapping guide shift length, the neck leader shift length and the standard marker shift length to the designed neck height in said step of calculating the actual neck height of the write-main magnetic pole.

With this method, shifts of the first standard marker and the second standard marker can be absorbed, so that the neck height can be more precisely measured.

In the method, a first overlay marker may be formed in said step of forming the first standard marker, a second overlay marker may be formed in said step of forming the second standard marker, and the standard marker shift length may be measured on the basis of shift lengths of the first overlay marker and the second overlay marker.

With this method, the standard marker shift length can be precisely gained.

The method may further comprise the steps of: forming a standard overlay marker in a layer, which is formed under a layer including the first overlay marker; measuring a first overlay marker shift length, in the anteroposterior direction, between the standard overlay marker and the first overlay marker; and measuring a second overlay marker shift length, in the anteroposterior direction, between the standard overlay marker and the second overlay marker, wherein the standard marker shift length is calculated on the basis of a difference between the first overlay marker shift length and the second overlay marker shift length.

In the method, at least one of the first standard marker and the second standard marker may be formed, by a photolithographic method, with resist.

With this method, the standard marker can be precisely formed by the photolithographic method, so that the shift lengths with respect to the standard marker can be correctly measured.

In the method, the first standard marker may be line-symmetrically formed in the anteroposterior direction, and a distance, in the anteroposterior direction, between the actual position of the rear end of the lapping guide and an anteroposterior center of the first standard marker may be measured.

With this method, the first standard marker is line-symmetrically formed in the anteroposterior direction. Even if the first standard marker is shrunk during the processing step, the standard center of the first standard marker in the anteroposterior direction is not changed. Therefore, the shift length of the rear end of the lapping guide can be correctly measured.

In the method, the first standard marker may be formed on an anteroposterior center line of the lapping guide.

With this method, the lapping guide shift length can be easily and correctly gained by measuring a linear distance between the first standard marker and the rear end of the lapping guide.

In the method, the second standard marker may be line-symmetrically formed in the anteroposterior direction, and a distance, in the anteroposterior direction, between the actual position of the neck leader and an anteroposterior center of the second standard marker may be measured.

With this method, the second standard marker is line-symmetrically formed in the anteroposterior direction. Even if the second standard marker is shrunk during the processing step, the standard center of the second standard marker in the anteroposterior direction is not changed. Therefore, the shift length of the neck leader can be correctly measured.

In the method, the second standard marker may be formed on an anteroposterior center line of the write-magnetic pole.

With this method, the neck leader shift length can be easily and correctly gained by measuring a linear distance between the second standard marker and the neck leader.

The method of producing a thin film magnetic head for vertical magnetic recording comprises the steps of one the above described methods, wherein an angle of a floating surface is adjusted so as to approximate the neck height to the designed neck height, in the step of lapping the floating surface, when the measured neck height is different from the designed neck height.

With this method, the actual neck height of the write-main magnetic pole can be approximated to the designed value.

In the method of the present invention for measuring the gap depth of the thin film magnetic head for horizontal magnetic recording, the gap depth of the write-magnetic pole can be easily and correctly measured without being influenced by shrink, etc. in the step of etching the lapping guide. On the other hand, in the method of the present invention for measuring the neck height of the thin film magnetic head for vertical magnetic recording, the neck height of the write-magnetic pole can be easily and correctly measured without being influenced by shrink, etc. in the step of etching the lapping guide.

### BRIEF DESCRIPTION OF THE DRAWINGS

Embodiments of the present invention will now be described by way of examples and with reference to the accompanying drawings, in which:

FIGS. 1A-1D are explanation views showing a process for producing a thin film magnetic head for horizontal magnetic recording;

FIGS. 2E-2H are explanation views showing the process for producing the thin film magnetic head for horizontal magnetic recording;

FIGS. 3I-3K are explanation views showing the process for producing the thin film magnetic head for horizontal magnetic recording;

FIGS. 4A and 4B are explanation views showing a process for calculating a read-element shift length with using a first standard marker;

FIGS. 5A and 5B are explanation views showing a process for calculating a zero throat shift length with using a second standard marker;

FIG. 6 is an explanation view of an overlay marker;

FIG. 7 is an explanation view of the thin film magnetic head for horizontal magnetic recording;

FIG. 8 is an explanation view showing a process for adjusting a gap depth of the thin film magnetic head for horizontal magnetic recording;

FIG. 9 is an explanation view of a thin film magnetic head for vertical magnetic recording;

FIG. 10 is an explanation view of a write-magnetic pole of the thin film magnetic head for vertical magnetic recording;

FIG. 11 is an explanation view showing a process for calculating a lapping guide shift length with using the first standard marker;

FIG. 12 is an explanation view showing a process for calculating a neck leader shift length with using the second standard marker;

FIG. 13 is an explanation view showing a process for adjusting a neck height of the thin film magnetic head for vertical magnetic recording;

FIGS. 14A-14C are explanation views showing the process for producing the sliders from the wafer substrate;

FIG. 14D is an explanation view of the conventional breaking test; and

FIG. 15 is an explanation view showing the conventional method of producing the thin film magnetic head.

### DETAILED DESCRIPTION OF THE EMBODIMENTS

Preferred embodiments of the present invention will now be described in detail with reference to the accompanying drawings.

### First Embodiment

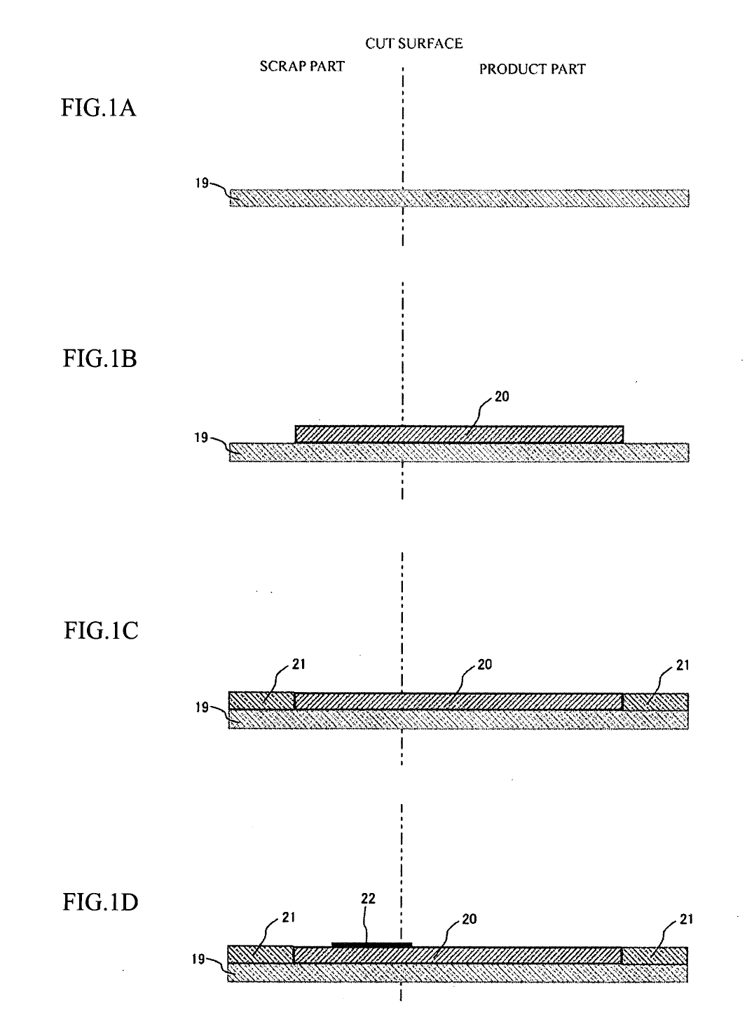

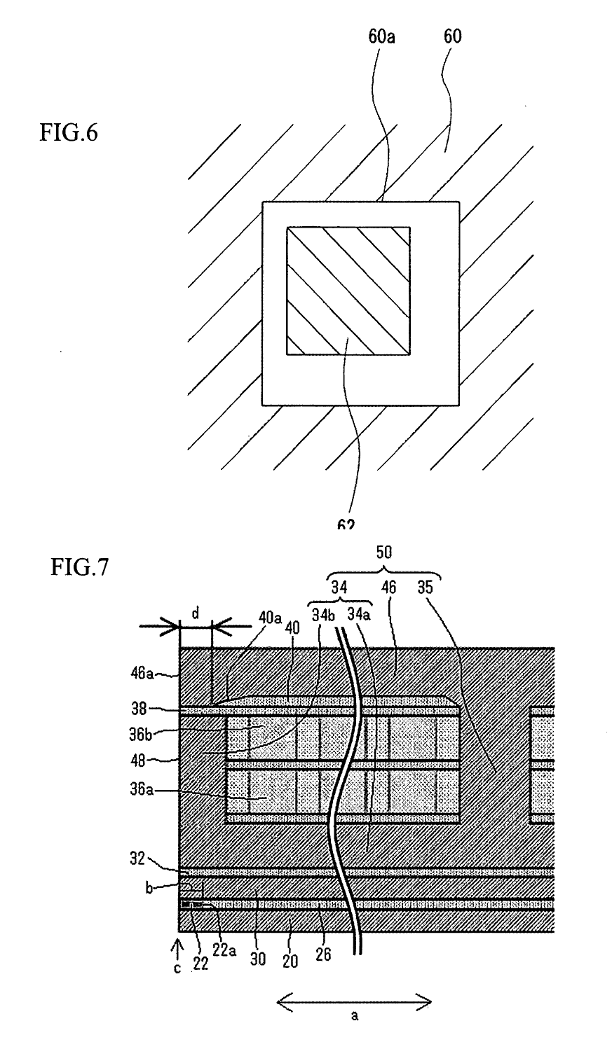

Firstly, a process for producing a thin film magnetic head for horizontal magnetic recording shown in FIG. 7 will be explained with reference to FIGS. 1A-3K, which are side sectional views. Note that, in FIGS. 1A-3K, a “cut surface” along a two-dot chain line indicates a floating surface of the completed thin film magnetic head. A “product part” will be left as the completed thin film magnetic head; a “scrap part” will be removed, from the completed thin film magnetic head, in a lapping step for forming the floating surface.

In FIG. 1A, a wafer substrate 19 is constituted by an AlTiC base and an insulating film, which is composed of alumina and formed on the AlTiC base by sputtering.

In FIG. 1B, a lower shielding layer 20 of a read-head is formed by wet plating. For example, the lower shielding layer 20 is formed by the steps of: forming a power feed layer for plating on the entire surface of the wafer substrate 19 by sputtering; forming a photoresist layer, which has a shape corresponding to that of the lower shielding layer 20, on the power feed layer; forming the lower shielding layer 20, by electrolytic plating, with feeding an electric power to the power feed layer; removing the photoresist layer; and removing the power feed layer, which has been exposed by removing the photoresist layer, by ion milling.

A material of the lower shielding layer 20 is not limited. In the present embodiment, the lower shielding layer 20 is composed of a magnetic material including nickel and iron. A thickness of the lower shielding layer 20 is several μm.

In FIG. 1C, an alumina layer 21 is formed on the entire surface of the wafer substrate 19 including the lower shielding layer 20 by sputtering, and its surface is polished so as to flatten surfaces of the alumina layer 21 and the lower shielding layer 20. By the flattening process, positioning accuracy and form accuracy of wire cables, which will be formed in the following step, can be improved.

Next, a CIP type magnetoresistance effect element layer is formed on the entire surfaces of the alumina layer 21 and the lower shielding layer 20. A resist layer is formed on a part of the magnetoresistance effect element layer, in which a read-element 22 will be formed, and the exposed part of the magnetoresistance effect element layer, which is exposed from the resist layer, is removed by, for example, ion beam etching, so that the CIP type read-element 22 shown in FIG. 1D can be produced.

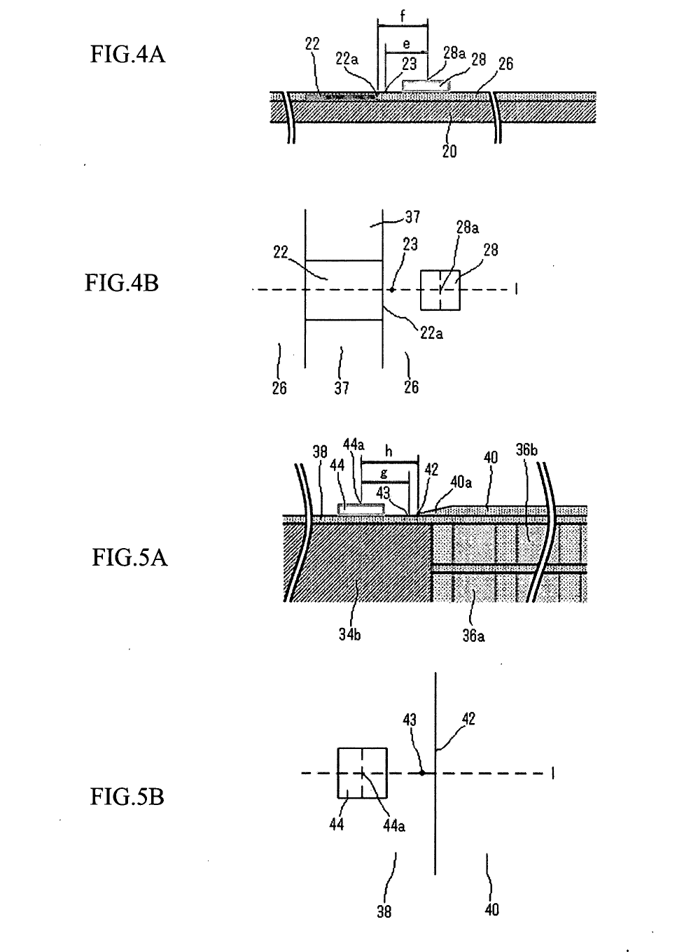

Next, hard bias films (not shown) are formed on the both sides (on the front side and the rear side in FIG. 7) of the read-element 22. An insulating film 26 is formed on the rear side of the read-element 22 as shown in FIG. 4A, which is an anteroposterior sectional view, and FIG. 4B, which is a plan view.

As shown in FIGS. 4A and 4B, a first standard marker 28 composed of photoresist is formed on the insulating film 26 by a photolithographic method. The first standard marker 28 is line-symmetrically formed in the anteroposterior direction. For example, the first standard marker 28 is formed into a rectangular shape whose two sides are paralleled in the anteroposterior direction. An anteroposterior center 28a of the first standard marker 28 is located at a position which is backwardly shifted a first specified distance e, in the anteroposterior direction, from a designed position 23 of a rear end of the read-element 22. As shown in FIG. 4B, the first standard marker 28 is formed on an anteroposterior center line 1 of the read-element 22 (a center line of a core). Note that, in FIG. 4B, symbols 37 stand for the hard bias films.

In the present embodiment, a designed position (desired position) of the rear end of the resist layer for forming the read-element 22 may be used as the designed position 23 of the rear end of the read-element 22.

A first overlay marker for detecting interlayer shift is formed on a part of the wafer substrate 19 (the insulating film 26), in which the thin film magnetic head is not formed, with resist, by the same method for forming the first standard marker 28.

The first overlay marker will be described later.

Next, the wafer substrate 19 is imaged from the upper side so as to measure an anteroposterior distance f between an actual position of the rear end 22a of the read-element 22 and the anteroposterior center 28a of the first standard marker 28. The measurement is performed by an image processing apparatus, which comprises imaging means, e.g., camera, for imaging the wafer substrate 19 from the upper side and a control section (computer) capable of processing image data inputted by the imaging means. Image processing means of the control section recognizes the position of the rear end 22a of the read-element 22 and the position of the anteroposterior center 28a of the first standard marker 28 and measures the distance f therebetween on the basis of the image data of the wafer substrate 19, which have been imaged from the upper side.

Further, the control section calculates a read-element shift length (f-e), which is the difference between the distance f and the first specified distance e and stores the read-element shift length in a storing section of the control section. Note that, the first specified distance e has been previously stored in the storing section of the control section.

The read-element shift length (f-e) indicates a shift length of the actual position of the rear end 22a of the read-element 22, in the anteroposterior direction, from the designed position 23 thereof.

The data of the read-element shift length include a shifting direction (shifting anteriorward or posteriorward) of the actual position of the rear end 22a of the read-element 22. The direction may be indicated by, for example, the positive sign (+) and the negative sign (−).

In the first embodiment, when the rear end 22a of the read-element 22 is shifted anteriorward from the designed position thereof, the read-element shift length (f−e) is a positive value; when the rear end 22a of the read-element 22 is shifted posteriorward from the designed position thereof, the read-element shift length (f−e) is a negative value.

Next, the first standard marker 28 and the first overlay marker are removed by a solvent.

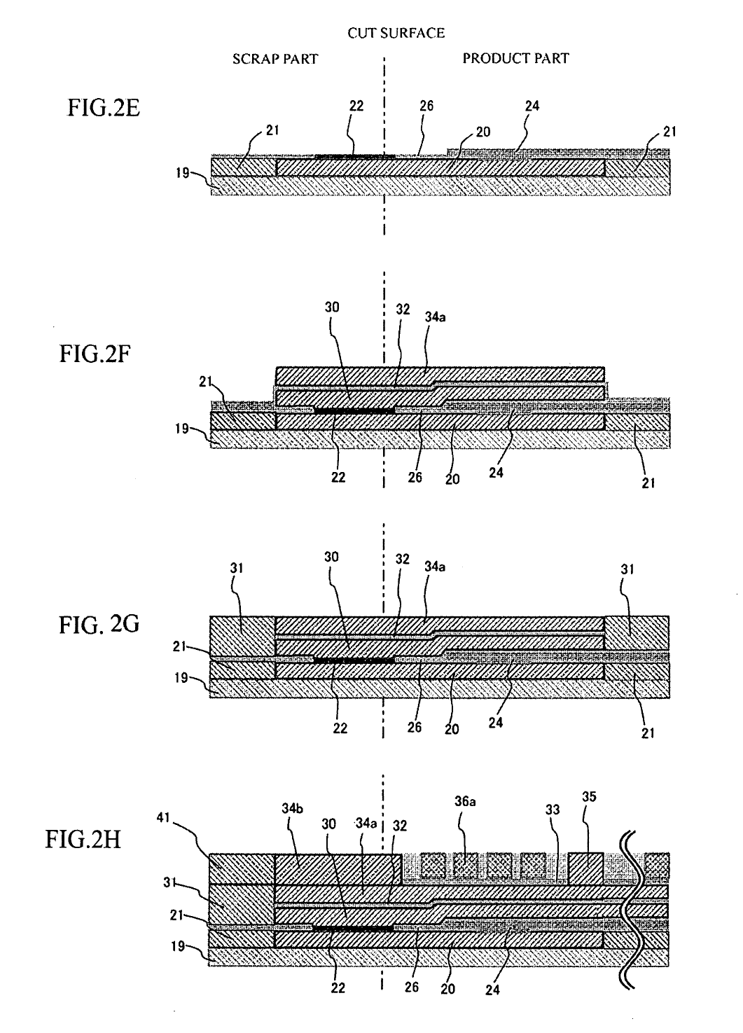

Next, as shown in FIG. 2E, cables 24 electrically connected to the read-element 22 are formed on the alumina layer 21 and the lower shielding layer 20. For example, the cables 24 are formed by the steps of: forming a photoresist layer, whose shape corresponds to the cables 24, on the alumina layer 21 and the lower shielding layer 20; forming the cables 24 by sputtering; and removing the photoresist layer and a useless metal stuck by sputtering with a solvent.

Next, as shown in FIG. 2F, an upper shielding layer 30 is formed on the read-element 22, the insulating film 26 and the hard bias films (not shown). Then, an insulating film 32 is formed on the upper shielding layer 30. Further, a bottom section 34a of a lower magnetic pole 34 of a write-head is formed on the insulating film 32.

Note that, a method of forming the upper shielding layer 30 and the bottom section 34a of the lower magnetic pole 34 and materials of thereof are the same as those of the lower shielding layer 20, so explanation will be omitted.

Next, an alumina layer 31 is formed on the entire surface of the wafer substrate 19 including the bottom section 34a of the lower magnetic pole 34 by sputtering. Then, the surface of the alumina layer 31 is polished so as to flatten the alumina layer 31 and the bottom section 34a of the lower magnetic pole 34 as shown in FIG. 2G. By the flattening process, positioning accuracy and form accuracy of coils, etc., which are formed in the following steps, can be improved.

Next, as shown in FIG. 2H, an insulating film 33, a front end section 34b of the lower magnetic pole 34 and a back gap 35 are formed on the bottom section 34a of the lower magnetic pole 34, and a first coil 36a enclosing the back gap 35 is formed on the insulating film 33. Then, an alumina layer 41 is formed on the entire surface by sputtering, and the surface is polished and flattened.

Next, a gap layer 38 (see FIG. 7) composed of an insulating material is formed on the front end section 34b of the lower magnetic pole 34 and a second coil 36b by sputtering.

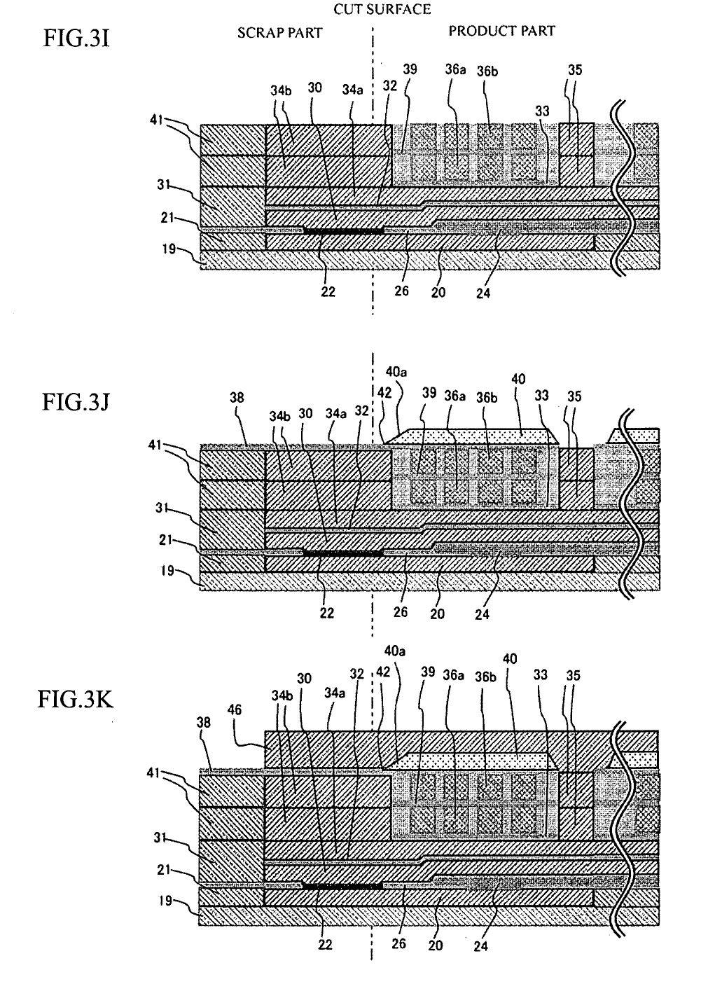

Further, an insulating layer 40 having a front end section 40a, which is inclined and whose thickness is gradually increased backward from a position located on the gap layer 38 and separated a prescribed distance away from the floating surface 48, is formed as shown in FIG. 3J.

As shown in FIGS. 5A and 5B, a second standard marker 44 composed of photoresist is formed on the insulating layer 40 by a photolithographic method. The second standard marker 44 is line-symmetrically formed in the anteroposterior direction. For example, the second standard marker 44 is formed into a rectangular shape whose two sides are paralleled in the anteroposterior direction. An anteroposterior center 44a of the second standard marker 44 is located at a position which is backwardly shifted a second specified distance g, in the anteroposterior direction, from a designed position 43 of a zero throat 42, and the designed anteroposterior position of the second standard marker 44 conforms to that of the first standard marker 28. As shown in FIG. 5, the second standard marker 44 is formed on an anteroposterior center line 1 of the write-head (a center line of a core).

A second overlay marker for detecting interlayer shift is formed on another part of the wafer substrate 19 (the insulating film 26), in which the thin film magnetic head is not formed, with resist, by the same method for forming the second standard marker 44.

The second overlay marker will be described later.

Next, the wafer substrate 19 is imaged from the upper side so as to measure an anteroposterior distance h between an actual position of the zero throat 42 and the anteroposterior center 44a of the second standard marker 44. The measurement is performed by the image processing apparatus. The image processing means of the control section recognizes the position of the zero throat 42 and the position of the anteroposterior center 44a of the second standard marker 44 and measures the distance h therebetween on the basis of the image data of the wafer substrate 19, which have been imaged from the upper side.

Further, the control section calculates a zero throat shift length (h−g), which is the difference between the distance h and the second specified distance g and stores the zero throat shift length in the storing section of the control section. Note that, the second specified distance g has been previously stored in the storing section of the control section.

The zero throat shift length (h−g) indicates a shift length of the actual position of the zero throat 42, in the anteroposterior direction, from the designed position 43 thereof.

The data of the zero throat shift length include a shifting direction (shifting anteriorward or posteriorward) of the actual position of the zero throat 42. The direction may be indicated by, for example, the positive sign (+) and the negative sign (−).

In the first embodiment, when the zero throat 42 is shifted anteriorward from the designed position thereof, the zero throat shift length (h-g) is a positive value; when the rear end 22a of the read-element 22 is shifted posteriorward from the designed position thereof, the zero throat shift length is a negative value.

The control section of the image processing apparatus measures a standard marker shift length, which is a relative shift length, in the anteroposterior direction, between the first standard marker 28 and the second standard marker 44.

The first standard marker 28 has been already removed, so the shift length between the first standard marker 28 and the second standard marker 44 cannot be directly measured. Thus, the standard marker shift length is measured by using the overlay markers.

Conventionally, overlay markers have been used to measure an overlay shift length between laminated layers of a thin film magnetic head. The overlay markers are formed at prescribed positions on a wafer substrate. The overlay markers are respectively formed in the laminated layers and composed of laminated structures of the layers or resist layers. After forming an object layer whose relative shift length will be measured, the shift length of the object layer is gained by measuring a relative shift length between the overlay markers corresponding to the object layer.

In the first embodiment, a standard overlay marker 60 is formed under a layer in which the first overlay marker or the first standard marker 28 is formed. For example, the standard overlay marker 60 is a metal structure shown in FIG. 6, which has a square wide opening 60a.

The first overlay marker 62, which is simultaneously formed when the first standard marker 28 is formed, is a square structure smaller than the square wide opening 60a and accommodated therein.

The control section of the image processing apparatus detects a shift length between a barycentric position of the opening 60a of the standard overlay marker 60 and that of first overlay marker 62, which is accommodated in the opening 60a, so as to measure a first overlay marker shift length, which is a shift length of the first overlay marker 62, in the anteroposterior direction, with respect to the standard overlay marker 60. The control section of the image processing apparatus stores data of the first overlay marker shift length in the storing section.

Then, the first overlay marker 62 is removed as described above.

In the following step, the second overlay marker, which is simultaneously formed when the second standard marker 44 is formed, is a square structure smaller than the square wide opening 60a and accommodated therein. A size and a shape of the second overlay marker are equal to those of the first overlay marker 62.

The control section of the image processing apparatus detects a shift length between a barycentric position of the opening 60a of the standard overlay marker 60 and that of second overlay marker, as well as the measurement of the first overlay marker 62, so as to measure a second overlay marker shift length, which is a shift length of the second overlay marker, in the anteroposterior direction, with respect to the standard overlay marker 60. The control section of the image processing apparatus stores data of the second overlay marker shift length in the storing section.

The control section calculates a difference between the first overlay marker shift length and the second overlay marker shift length so as to gain a relative shift length between the first overlay marker and the second overlay marker. The relative shift length between the first overlay marker and the second overlay marker is regarded as the standard marker shift length, which is a relative shift length between the first standard marker 28 and the second standard marker 44.

The first overlay marker is formed by the same process for forming the first standard marker 28, and the second overlay marker is formed by the same process for forming the second standard marker 44. Therefore, the shift length between first overlay marker and the second overlay marker is highly equal to the standard marker shift length.

The control section of the image processing apparatus stores data of the standard marker shift length i in the storing section.

The data of the standard marker shift length i include shifting directions (shifting anteriorward or posteriorward) of the actual positions of the first standard marker 28 and the second standard marker 44. The direction may be indicated by, for example, the positive sign (+) and the negative sign (−).

In the first embodiment, when the first standard marker 28 or the second standard marker 44 is shifted anteriorward from the designed position thereof, the shift length is a positive value; when the first standard marker 28 or the second standard marker 44 is shifted posteriorward from the designed position thereof, the shift length is a negative value.

Next, the second standard marker 44 and the second overlay marker, which are composed of photoresist, are removed by a solvent.

Next, an upper magnetic pole 46 is formed on the gap layer 38, the insulating layer 40 and the back gap 35 (see FIGS. 3K and 7). Note that, in the present invention, the magnetic pole including the lower magnetic pole 34, the back gap 35 and the upper magnetic pole 46 is called a write-magnetic pole 50 (see FIG. 7).

Further, a protection layer (not shown) is formed on the upper magnetic pole 46, and connecting terminals are formed. By these steps, a laminated structure of a slider is completely formed on the wafer substrate 19.

Successively, as described in FIGS. 14A-14C, the wafer substrate, in which the elements including the read-elements 22 and the write-magnetic poles 50 are arranged in a matrix, is cut to form into the raw bars 72, as well as the conventional method. The floating surface of each of the raw bars 72 is formed by the lapping process. Further, the raw bar 72 is cut to form the separated sliders 74.

In the lapping process, as described in BACKGROUND OF THE INVENTION, the position c of the floating surface 48, in the anteroposterior direction a, is defined by: detecting the width (MR height) b of the read-element (MR element) 22, in the anteroposterior direction a perpendicular to the floating surface 48; and adjusting the amount of lapping to approximate the width b to a prescribed value. Namely, the anteroposterior position c of the floating surface 48 is set on the basis of the rear end 22a of the read-element 22. In the lapping process, the MR height b of the read-element 22 is detected by measuring resistance, output voltage, etc. of read-terminals (not shown) connected to the read-element 22. Namely, the read-element 22 is used as a so-called resistance lapping guide (RLG).

The control section of the image processing apparatus calculates an actual gap depth of the write-magnetic pole 50 by adding the read-element shift length (f-e), which has been stored, the zero throat shift length (h-g), which has been stored, and the standard marker shift length i, which has been stored, to a designed gap depth (IGD). Namely, the control section calculates the actual gap depth by the following formula:

Actual Gap Depth=IGD+(f−e)+(h−g)+i

Note that, the formula is satisfied when the positive signs (+) and the negative signs (−) of the values (f−e), (h−g) and i are defined as described above. But, the present invention is not limited to the above formula. When the positive signs (+) and the negative signs (−) of the values are inverted, plus signs and minus signs of the formula are inverted.

The position of the floating surface is defined on the basis of the actual position of the rear end of the read-element. The gap depth is a distance between the floating surface and the zero throat, so the actual gap depth of the write-magnetic pole 50 is gained by adding the read-element shift length (f−e), which has been stored, the zero throat shift length (h−g), which has been stored, and the standard marker shift length i, which has been stored, to a designed gap depth IGD.

By adding the standard marker shift length i, positioning errors of the first standard marker 28 and the second standard marker 44 can be corrected, so that the correct gap depth can be measured.

The actual gap depth measured is given feedback to the laminating step of the production process of the following thin film magnetic head. Namely, when the actual gap depth is different from the designed gap depth, the laminating positions of the thin films, etc. are precisely adjusted so as to approximate the actual gap depth to the designed gap depth in the production process of the following thin film magnetic head.

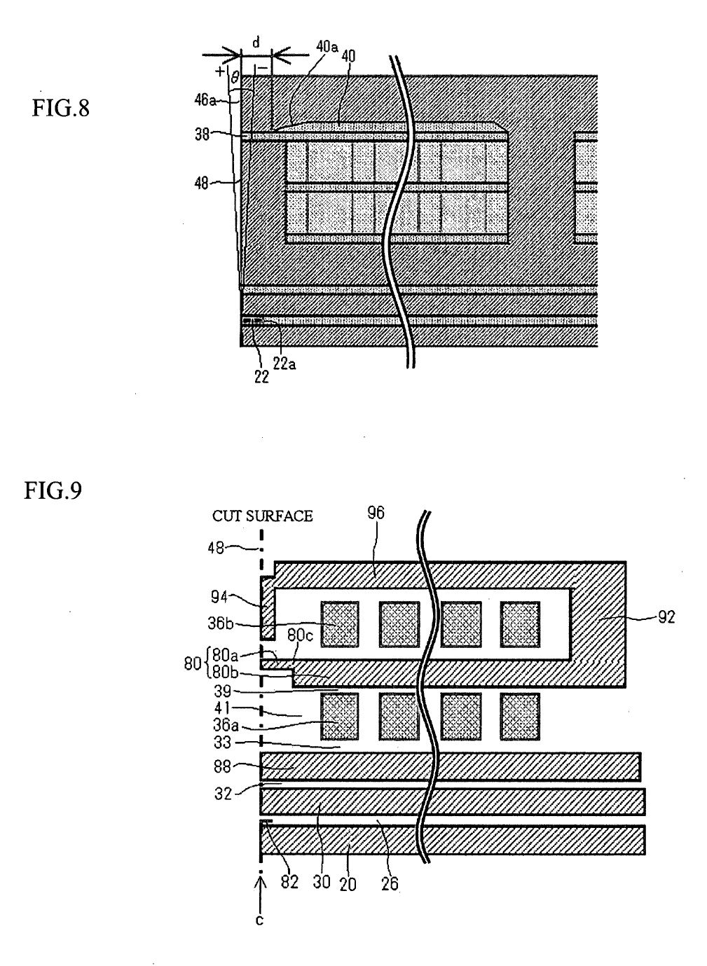

The actual gap depth measured can be used for not only the above described feedback control but also other purposes. For example, in case that the gap depth is calculated by the method of the first embodiment before lapping the floating surface 48 and the calculated gap depth is different from the designed gap depth, an angle θ of the floating surface 48 (see FIG. 8) is adjusted so as to approximate the actual gap depth d to the designed gap depth. This method may be applied to adjust an inclination angle of the raw bar 72 in the step of lapping the raw bar 72. In case that the angle θ=0° and the actual gap depth d measured by the method of the first embodiment is smaller than the designed gap depth, the angle θ of the floating surface 48 is varied toward the plus (+) side (see FIG. 8); in case that the actual gap depth measured by the method of the first embodiment is greater than the designed gap depth, the angle θ is varied toward the minus (−) side (see FIG. 8). With this method, the actual gap depth d can be adjusted without changing the MR height of the read-element 22.

In the first embodiment, the first standard marker 28 and the second standard marker 44 are formed between the rear end 22a of the read-element 22 and the zero throat 42 arranged in the anteroposterior direction. With this structure, a distance between the first standard marker 28 and the rear end 22a of the read-element 22 and a distance between the second standard marker 44 and the zero throat 42 can be minimized, so that the distances can be measured precisely. However, in the present invention, their arrangement is not limited. For example, the first standard marker 28 and the second standard marker 44 may be located at other places.

In the first embodiment, the first standard marker 28 and the second standard marker 44 are formed on the center line 1 of the core so as to easily measure the distances. As far as the distances in the anteroposterior direction can be measured, they may be displaced from the center line 1.

In the first embodiment, the first standard marker 28 and the second standard marker 44 are line-symmetrically formed in the anteroposterior direction so as not to displace their centers even if they are deformed in the production process. However, the present invention is not limited to the line-symmetrical forms.

In the first embodiment, the standard marker shift length i is used to correct the positioning errors of the first standard marker 28 and the second standard marker 44. The present invention is not limited to the embodiment.

In comparison with the position of the rear end 22a of the read-element 22 and the position of the zero throat 42 which are easily varied by etching conditions, the first standard marker 28 and the second standard marker 44 can be formed at the correct positions by the photolithographic method. Therefore, the correct gap depth can be measured without adding the standard marker shift length i, so adding the standard marker shift length i may be omitted.

The designed positions of the first standard marker 28 and the second standard marker 44 in the anteroposterior direction need not be conformed. They may be formed at optional positions.

In the first embodiment, the CIP type read-element 22 is used as the lapping guide (resistance lapping guide), but the present invention is not limited to this structure. For example, a resistance lapping guide may be provided to a position separated from a specified position, at which an element of the thin film magnetic head will be formed.

### Second Embodiment

A method of measuring a neck height of a thin film magnetic head for vertical magnetic recording will be explained.

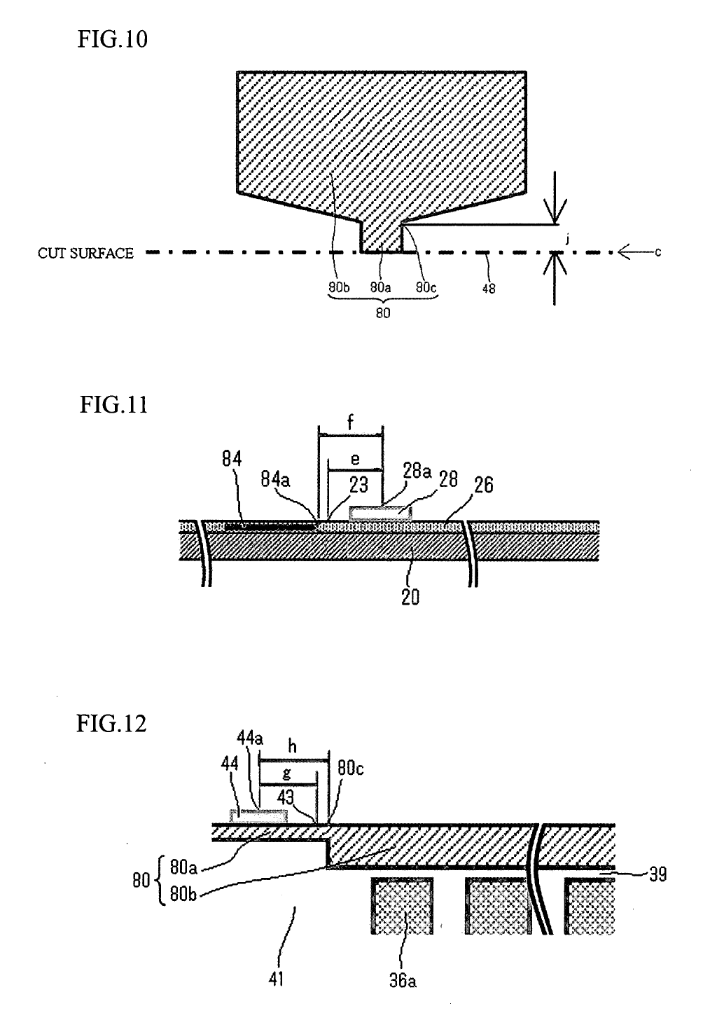

FIG. 9 is an anteroposterior sectional view of the thin film magnetic head for vertical magnetic recording. FIG. 10 is an explanation view of a write-main magnetic pole 80 of the thin film magnetic head seen from the upper side.

As shown in FIG. 10, the write-main magnetic pole 80 of the thin film magnetic head for vertical magnetic recording has: a neck section 80a, which is a front end part located on the floating surface 48 side and whose core width is constant and narrow; and a yoke section 80b, which is a rear end part and whose width is gradually increased toward the rear end from the neck section 80a. In the present invention, a border between the neck section 80a and the yoke section 80b is called a neck leader 80c. The neck height j is a distance between the neck leader 80c and the floating surface 48, i.e., a length of the neck section 80a after forming the floating surface 48.

As shown in FIG. 10, the neck height j is the distance between the neck leader 80c and the floating surface 48, so it is influenced by the anteroposterior position c of the floating surface 48, which is defined by a lapping process. If the position c of the floating surface 48 is located on the anteriorward with respect to the neck leader 80c, the neck height j is great; if the position c of the floating surface 48 is located on the posteriorward with respect to the neck leader 80c, the neck height j is small.

In the thin film magnetic head for vertical magnetic recording, the neck height j highly influences a write-characteristic of the write-main magnetic pole 80.

In the second embodiment, the neck height j of the thin film magnetic head for vertical magnetic recording can be measured without performing the sample breaking test (see FIG. 14D).

The method of the second embodiment, in which the neck height of the thin film magnetic head for vertical magnetic recording is measured, will be explained with a production process thereof. Note that, the structural elements explained in the first embodiment are assigned the same symbols and explanation will be omitted.

The lower shielding layer 20 of a read-head 82 is formed on the wafer substrate (not shown in FIG. 9) by wet plating. Then, the surface of the lower shielding layer 20 is polished and flattened.

Next, the read-element 82, which is a TMR element or a CPP type GMR element, is formed on the lower shielding layer 20.

Next, hard bias films (not shown) are formed on the both sides (on the front side and the rear side in FIG. 7) of the read-element 82. The insulating film 26 is formed on the rear side of the read-element 82.

Further, a resistance lapping guide, which reaches the cut surface, is formed on a part of the insulating film 26, which is displaced from a specified area in which the slider 74 will be formed. For example, the “specified area in which the slider 74 will be formed” is an area 72a of the raw bar 72 (see FIG. 14D), which is sandwiched between the sliders 74. An example of the resistance lapping guide is shown in FIG. 11. FIG. 11 shows an anteroposterior sectional view of the resistance lapping guide 84.

In the following lapping process for forming the floating surface 48, electric resistance of the resistance lapping guide 84 is detected so as to adjust the amount of lapping. The electric resistance of the resistance lapping guide 84 is increased with lapping the resistance lapping guide 84 and reducing the width thereof. When the resistance value reaches a predetermined value, the lapping work is stopped, so that the amount of lapping can be adjusted.

In the first embodiment, the CIP type read-element 22 is used as the resistance lapping guide. On the other hand, in the second embodiment, the read-element 82 is the TMR element or the CPP type GMR element, so the read-element 82 cannot be used as the resistance lapping guide. Thus, the resistance lapping guide 84 is separately formed.

After forming the resistance lapping guide 84, the first standard marker 28 composed of photoresist is formed on the insulating film 26 by a photolithographic method. The anteroposterior center 28a of the first standard marker 28 is located at the position which is backwardly shifted the first specified distance e, in the anteroposterior direction, from a designed position 86 of a rear end of the resistance lapping guide 84. The first standard marker 28 is formed on an anteroposterior center line 1 of the resistance lapping guide 84.

The first overlay marker for detecting interlayer shift is formed on the part of the wafer substrate (the insulating film 26), in which the thin film magnetic head is not formed, with resist, by the same method for forming the first standard marker 28.

Next, the wafer substrate is imaged from the upper side so as to measure an anteroposterior distance f between an actual position of the rear end 84a of the resistance lapping guide 84 and the anteroposterior center 28a of the first standard marker 28. The measurement is performed by the image processing apparatus used in the first embodiment. The image processing means of the control section recognizes the position of the rear end 84a of the resistance lapping guide 84 and the position of the anteroposterior center 28a of the first standard marker 28 and measures the distance f therebetween on the basis of the image data of the wafer substrate, which have been imaged from the upper side.

Further, the control section calculates a lapping guide shift length (f−e), which is the difference between the distance f and the first specified distance e and stores the lapping guide shift length in the storing section of the control section. Note that, the first specified distance e has been previously stored in the storing section of the control section.

The lapping guide shift length (f−e) indicates a shift length of the actual position of the rear end 84a of the lapping guide 84, in the anteroposterior direction, from the designed position 23 thereof.

The data of the lapping guide shift length include a shifting direction (shifting anteriorward or posteriorward) of the actual position of the rear end 84a of the lapping guide 84. The direction may be indicated by, for example, the positive sign (+) and the negative sign (−).

In the second embodiment, when the rear end 84a of the lapping guide 84 is shifted anteriorward from the designed position thereof, the lapping guide shift length (f−e) is a positive value; when the rear end 84a of the lapping guide 84 is shifted posteriorward from the designed position thereof, the lapping guide shift length (f−e) is a negative value.

Next, the first standard marker 28 and the first overlay marker are removed by a solvent.

Next, as shown in FIG. 9, the upper shielding layer 30 is formed on the read-element 82, the insulating film 26 and the hard bias films (not shown).

Then, the insulating film 32 is formed on the upper shielding layer 30.

Further, a shielding layer 88 of the write-head is formed on the insulating film 32.

An insulating film 33 is formed on the shielding layer 88, and a first coil 36a is formed on the insulating film 33. Then, an alumina layer 41 is formed on the entire surface by sputtering, and the surface of the alumina layer 41 is polished and flattened. Further, an alumina film 39 is formed on the first coil 36a by sputtering.

Next, the write-main magnetic pole 80 is formed on the alumina film 39 by the steps of: forming a basic structure including the neck section 80a and the yoke section 80b by a photolithographic method; slimming side faces of the basic structure; and chemical-mechanical-polishing an upper face thereof.

As shown in FIG. 12, the second standard marker 44 composed of photoresist is formed on the write-main magnetic pole 80 by a photolithographic method after forming the write-main magnetic pole 80. The second standard marker 44 is line-symmetrically formed in the anteroposterior direction. For example, the second standard marker 44 is formed into a rectangular shape whose two sides are paralleled in the anteroposterior direction. The anteroposterior center 44a of the second standard marker 44 is located at a position which is backwardly shifted a second specified distance g, in the anteroposterior direction, from a designed position 90 of the neck leader 80c. As shown in FIG. 5, the second standard marker 44 is formed on the anteroposterior center line 1 of the write-head (the center line of the core).

The second overlay marker for detecting interlayer shift is formed on a part of the wafer substrate (the insulating film 26), in which the thin film magnetic head is not formed, with resist, by the same method for forming the second standard marker 44.

Next, the wafer substrate is imaged from the upper side so as to measure an anteroposterior distance h between an actual position of the neck leader 80c and the anteroposterior center 44a of the second standard marker 44. The measurement is performed by the image processing apparatus. The image processing means of the control section recognizes the position of the neck leader 80c and the position of the anteroposterior center 44a of the second standard marker 44 and measures the distance h therebetween.

Further, the control section calculates a neck leader shift length (h−g), which is the difference between the distance h and the second specified distance g and stores the neck leader shift length in the storing section of the control section. Note that, the second specified distance g has been previously stored in the storing section of the control section.

The neck leader shift length (h−g) indicates a shift length of the actual position of the neck leader 80c, in the anteroposterior direction, from the designed position 43 thereof.

The data of the neck leader shift length include a shifting direction (shifting anteriorward or posteriorward) of the actual position of the neck leader 80c. The direction may be indicated by, for example, the positive sign (+) and the negative sign (−).

In the second embodiment, when the neck leader 80c is shifted anteriorward from the designed position thereof, the neck leader shift length (h−g) is a positive value; when the neck leader 80c is shifted posteriorward from the designed position thereof, the neck leader shift length is a negative value.

The control section of the image processing apparatus measures the standard marker shift length, which is a difference between: the anteroposterior shift length between the actual position of the first standard marker and the designed position thereof; and the anteroposterior shift length between the actual position of the second standard marker and the designed position thereof.

This method is the same as the first embodiment, in which the overlay markers are used. Namely, the standard marker shift length is calculated from the difference between: the shift length of the first overlay marker with respect to the standard overlay marker; and the shift length of the second overlay marker with respect to the standard overlay marker.

Unlike the first embodiment, the designed anteroposterior positions of the first standard marker 28 and the second standard marker 44 are not conformed. But, in the second embodiment, the method of calculating the standard marker shift length is the same as that of the first embodiment.

Next, a back gap 92 is formed on the rear side of the write-main magnetic pole 80, and an alumina film is formed on the write-main magnetic pole 80. Further, a second coil 36b, which encloses the back gap 92, is formed on the alumina film. A trailing shield 94 is formed above a front end of the write-main magnetic pole 80. With this structure, the trailing shield 94 is separated from the write-main magnetic pole 80. An alumina film is formed on the second coil 36b, and a return yoke 96, which is connected to the back gap 92 and the trailing shield 94, is formed on the alumina film.

Further, a protection layer (not shown) is formed on the return yoke 96, and connecting terminals are formed. By these steps, a laminated structure of a slider is completely formed on the wafer substrate 19.

Successively, the wafer substrate is cut to form into the raw bars, as well as the first embodiment.

In the lapping process, the position c of the floating surface 48, in the anteroposterior direction a, is defined by: detecting the width of the resistance lapping guide 84, in the anteroposterior direction perpendicular to the floating surface 48; and adjusting the amount of lapping to approximate the width to a prescribed value. Namely, the anteroposterior position c of the floating surface 48 is set on the basis of the rear end 84a of the resistance lapping guide 84. In the lapping process, the width of the resistance lapping guide 84 is detected by measuring resistance, output voltage, etc. of the resistance lapping guide 84.

In the second embodiment, the resistance lapping guide 84 and the read-element 82 are formed in the same layer, but the present invention is not limited to this structure.

For example, the resistance lapping guide 84 and the write-main magnetic pole 80 may be formed in the same layer, or the resistance lapping guide 84 may formed in a layer adjacent to the layer including the write-main magnetic pole 80. With this structure, a distance between the write-main magnetic pole 80 and the resistance lapping guide 84 in the laminating direction can be shortened, so that the neck height can be correctly formed in the process for lapping the floating surface 48.

The control section of the image processing apparatus calculates an actual neck height of the write-main magnetic pole 80 by adding the lapping guide shift length (f−e), which has been stored, the neck leader shift length (h−g), which has been stored, and the standard marker shift length i, which has been stored, to a designed neck height (INH). Namely, the control section calculates the actual gap depth by the following formula:

Actual Neck Height=INH+(f−e)+(h−g)+i

Note that, the formula is satisfied when the positive signs (+) and the negative signs (−) of the values (f−e), (h−g) and i are defined as described above. But, the present invention is not limited to the above formula. When the positive signs (+) and the negative signs (−) of the values are inverted, plus signs and minus signs of the formula are inverted.

The position of the floating surface is defined on the basis of the actual rear end of the lapping guide. The neck height is a distance between the floating surface and the neck leader, so the actual neck height of the write-main magnetic pole 80 can be gained by adding the lapping guide shift length (f−e), which has been stored, the neck leader shift length (h−g), which has been stored, and the standard marker shift length i, which has been stored, to a designed neck height INH.

By adding the standard marker shift length i, positioning errors of the first standard marker 28 and the second standard marker 44 can be corrected, so that the correct neck height can be measured.

The neck height measured is given feedback to the laminating step of the production process of the following thin film magnetic head. Namely, when the actual neck height is different from the designed height, the laminating positions of the thin films, etc. are precisely adjusted so as to approximate the actual neck height to the designed neck height in the production process of the following thin film magnetic head.

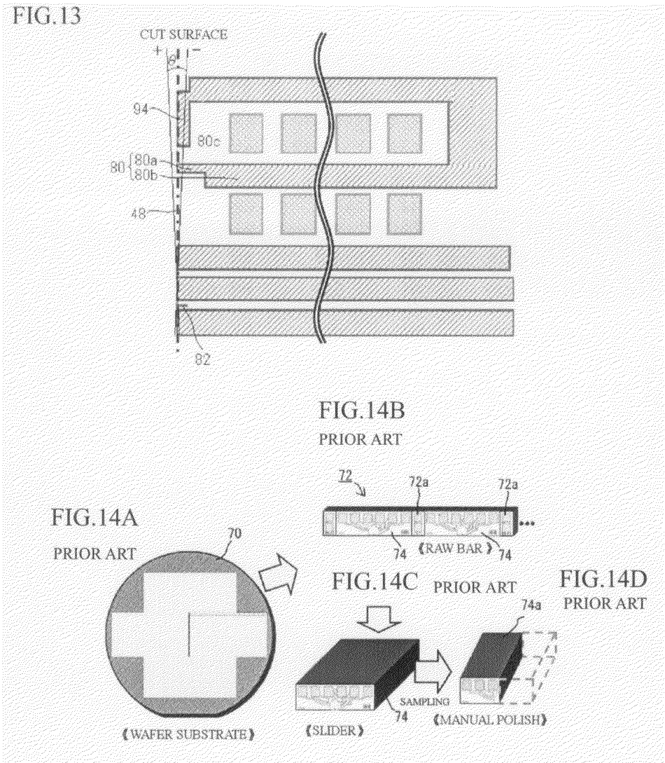

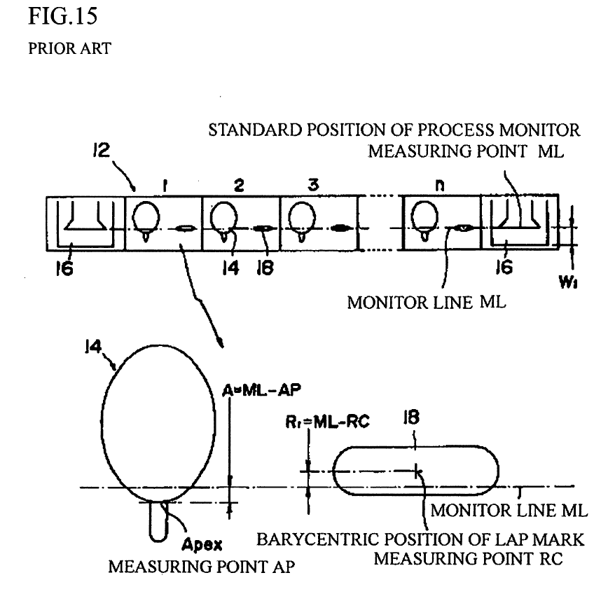

The actual neck height measured can be used for not only the above described feedback control but also other purposes. For example, in case that the neck height is calculated by the method of the second embodiment before lapping the floating surface 48 and the calculated neck height is different from the designed neck height, an angle θ of the floating surface 48 (see FIG. 13) is adjusted so as to approximate the actual neck height to the designed neck height. This method may be applied to adjust the inclination angle of the raw bar 72 in the step of lapping the raw bar 72. In case that the angle θ=0° and the actual neck height measured by the method of the second embodiment is smaller than the designed neck height, the angle θ of the floating surface 48 is varied toward the plus (+) side (see FIG. 13); in case that the actual neck height measured by the method of the second embodiment is greater than the designed neck height, the angle θ is varied toward the minus (−) side (see FIG. 13). With this method, the actual neck height can be adjusted without changing the MR height of the read-element 82.

In the second embodiment, the first standard marker 28 and the second standard marker 44 are formed on the center line 1 of the core so as to easily measure the distances. As far as the distances in the anteroposterior direction can be measured, they may be displaced from the center line 1.

In the second embodiment, the first standard marker 28 and the second standard marker 44 are line-symmetrically formed in the anteroposterior direction so as not to displace their centers even if they are deformed in the production process. However, the present invention is not limited to the line-symmetrical forms.

In the second embodiment, the standard marker shift length i is used to correct the positioning errors of the first standard marker 28 and the second standard marker 44. The present invention is not limited to the embodiment.

In comparison with the position of the rear end 22a of the read-element 22 and the position of the neck leader 80c which are easily varied by etching conditions, the first standard marker 28 and the second standard marker 44 can be formed at the correct positions by the photolithographic method. Therefore, the correct neck height can be measured without adding the standard marker shift length i, so adding the standard marker shift length i may be omitted.

The invention may be embodied in other specific forms without departing from the spirit of essential characteristics thereof. The present embodiments are therefore to be considered in all respects as illustrative and not restrictive, the scope of the invention being indicated by the appended claims rather than by the foregoing description and all changes which come within the meaning and range of equivalency of the claims are therefore intended to be embraced therein.

What is claimed is:

1. A method of measuring a gap depth of a thin film magnetic head for horizontal magnetic recording,
comprising the steps of:
forming a lapping guide;
forming a first standard marker at a position which is shifted a first specified distance, in an anteroposterior direction, from a designed position of a rear end of the lapping guide;
measuring a distance, in the anteroposterior direction, between an actual position of the rear end of the lapping guide and the position of the first standard marker;
calculating a lapping guide shift length, which is a length between the measured distance and the first specified distance;
forming a gap layer of a write-magnetic pole for horizontal magnetic recording;
forming an insulating layer, which has an apex part, on the gap layer;
forming a second standard marker at a position which is shifted a second specified distance, in the anteroposterior direction, from a designed position of a zero throat of the apex part;
measuring a distance, in the anteroposterior direction, between an actual position of the zero throat and the position of the second standard marker;
calculating a zero throat shift length, which is a length between the measured distance and the second specified distance; and
calculating an actual gap depth of the write-magnetic pole by adding the lapping guide shift length and the zero throat shift length to a designed gap depth.

2. A method of measuring a gap depth of a thin film magnetic head for horizontal magnetic recording,
comprising the steps of:
forming a lapping guide;
forming a first standard marker at a position which is shifted a first specified distance, in an anteroposterior direction, from a designed position of a rear end of the lapping guide;
measuring a distance, in the anteroposterior direction, between an actual position of the rear end of the lapping guide and the position of the first standard marker;
storing a datum of a lapping guide shift length, which is a length between the measured distance and the first specified distance, in a storing section;
forming a gap layer of a write-magnetic pole for horizontal magnetic recording;
forming an insulating layer, which has an apex part, on the gap layer;
forming a second standard marker at a position which is shifted a second specified distance, in the anteroposterior direction, from a designed position of a zero throat of the apex part;
measuring a distance, in the anteroposterior direction, between an actual position of the zero throat and the position of the second standard marker;
storing a datum of a zero throat shift length, which is a length between the measured distance and the second specified distance, in the storing section; and
calculating an actual gap depth of the write-magnetic pole by adding the lapping guide shift length and the zero throat shift length, which have been stored as the data, to a designed gap depth.

3. The method according to claim 1,
further comprising the step of measuring a standard marker shift length, which is a difference between: a shift length of the first standard marker, in the anteroposterior direction, between a designed position of the first standard marker and an actual position thereof; and a shift length of the second standard marker, in the anteroposterior direction, between a designed position of the second standard marker and an actual position thereof,
wherein the actual gap depth of the write-magnetic pole is calculated by adding the lapping guide shift length, the zero throat shift length and the standard marker shift length to the designed gap depth in said step of calculating the actual gap depth of the write-magnetic pole.

4. The method according to claim 3,
wherein the designed positions of the first standard marker and the second standard marker in the anteroposterior direction are conformed.

5. The method according to claim 4,
wherein the first standard marker is formed at a position shifted rearward from the designed position of the rear end of the lapping guide, and
the second standard marker is formed at a position shifted forward from the designed position of the zero throat.

6. The method according to claim 3,
wherein a first overlay marker is formed in said step of forming the first standard marker,
a second overlay marker is formed in said step of forming the second standard marker, and
the standard marker shift length is measured on the basis of shift lengths of the first overlay marker and the second overlay marker.

7. The method according to claim 1,
wherein at least one of the first standard marker and the second standard marker is formed, by a photolithographic method, with resist.

8. The method according to claim 1,
wherein the first standard marker is line-symmetrically formed in the anteroposterior direction, and
a distance, in the anteroposterior direction, between the actual position of the rear end of the lapping guide and an anteroposterior center of the first standard marker is measured.

9. The method according to claim 1,
wherein the second standard marker is line-symmetrically formed in the anteroposterior direction, and
a distance, in the anteroposterior direction, between the actual position of the zero throat and an anteroposterior center of the second standard marker is measured.

10. The method according to claim 1,
wherein the first standard marker and the second standard marker are formed on an anteroposterior center line of the lapping guide.

11. The method according to claim 1,
wherein the lapping guide is a CIP type read-element of the thin film magnetic head for horizontal magnetic recording.

12. A method of measuring a neck height of a thin film magnetic head for vertical magnetic recording,
comprising the steps of:
forming a lapping guide;
forming a first standard marker at a position which is shifted a first specified distance, in an anteroposterior direction, from a designed position of a rear end of the lapping guide;
measuring a distance, in the anteroposterior direction, between an actual position of the rear end of the lapping guide and the position of the first standard marker;
calculating a lapping guide shift length, which is a length between the measured distance and the first specified distance;
forming a write-main magnetic pole for vertical magnetic recording;
forming a second standard marker at a position which is shifted a second specified distance, in the anteroposterior direction, from a designed position of a neck leader, which is a border between a neck part and a yoke part of a pole end in the write-main magnetic pole;
measuring a distance, in the anteroposterior direction, between an actual position of the neck leader and the position of the second standard marker;
calculating a neck leader shift length, which is a length between the measured distance and the second specified distance; and
calculating an actual neck height of the write-main magnetic pole by adding the lapping guide shift length and the neck leader shift length to a designed neck height.

13. A method of measuring a neck height of a thin film magnetic head for vertical magnetic recording,
comprising the steps of:
forming a lapping guide;
forming a first standard marker at a position which is shifted a first specified distance, in an anteroposterior direction, from a designed position of a rear end of the lapping guide;
measuring a distance, in the anteroposterior direction, between an actual position of the rear end of the lapping guide and the position of the first standard marker;
storing a datum of a lapping guide shift length, which is a length between the measured distance and the first specified distance, in a storing section;
forming a write-main magnetic pole for vertical magnetic recording;
forming a second standard marker at a position which is shifted a second specified distance, in the anteroposterior direction, from a designed position of a neck leader, which is a border between a neck part and a yoke part of a pole end in the write-main magnetic pole;
measuring a distance, in the anteroposterior direction, between an actual position of the neck leader and the position of the second standard marker;
storing a datum of a neck leader shift length, which is a length between the measured distance and the second specified distance, in the storing section; and
calculating an actual neck height of the write-main magnetic pole by adding the lapping guide shift length and the neck leader shift length, which have been stored as the data, to a designed neck height.

14. The method according to claim 12,
further comprising the step of measuring a standard marker shift length, which is a difference between: a shift length of the first standard marker, in the anteroposterior direction, between a designed position of the first standard marker and an actual position thereof; and a shift length of the second standard marker, in the anteroposterior direction, between a designed position of the second standard marker and an actual position thereof,
wherein the actual gap depth of the write-magnetic pole calculated by adding the lapping guide shift length, the neck leader shift length and the standard marker shift length to the designed neck height in said step of calculating the actual neck height of the write-main magnetic pole.

15. The method according to claim 14,
wherein a first overlay marker is formed in said step of forming the first standard marker,
a second overlay marker is formed in said step of forming the second standard marker, and
the standard marker shift length is measured on the basis of shift lengths of the first overlay marker and the second overlay marker.

16. The method according to claim 12,
wherein at least one of the first standard marker and the second standard marker is formed, by a photolithographic method, with resist.

17. The method according to claim 12,
wherein the first standard marker is line-symmetrically formed in the anteroposterior direction, and
a distance, in the anteroposterior direction, between the actual position of the rear end of the lapping guide and an anteroposterior center of the first standard marker is measured.

18. The method according to claim 12,
wherein the second standard marker is line-symmetrically formed in the anteroposterior direction, and
a distance, in the anteroposterior direction, between the actual position of the neck leader and an anteroposterior center of the second standard marker is measured.

19. The method according to claim 12,
wherein the first standard marker and the second standard marker are formed on an anteroposterior center line of the lapping guide.
